(19) United States
(12) Patent Application Publication
(10) Pub. No.: US 2020/0117523 A1
(43) Pub. Date: Apr. 16, 2020

(54) STATISTICAL DEEP CONTENT INSPECTION OF API TRAFFIC TO CREATE PER-IDENTIFIER INTERFACE CONTRACTS

(71) Applicant: CA, Inc., NEW YORK, NY (US)

(72) Inventors: KENNETH WILLIAM SCOTT MORRISON, NEW WESTMINSTER (CA); JAY WILLIAM THORNE, PORT COQUITLAM (CA)

(21) Appl. No.: 16/160,537

(22) Filed: Oct. 15, 2018

(51) Int. Cl. G06F 9/54; G06N 99/00; H04L 12/26

(52) U.S. Cl. CPC G06F 9/547; H04L 43/08; G06N 99/005

(57) ABSTRACT

Embodiments of the present disclosure relate to deep content inspection of API traffic. Initially, messages are received from users of an API at an API gateway. The messages comprise a structure and metadata and are intended for an API server. The API gateway selectively communicates copies of the messages to a traffic sampler. The traffic sampler comprises a database of traffic samples, a machine learning system, and a database comprising one or more models. The traffic sample communicates the models corresponding to usage of the API servers to the API gateway. The models are built by the machine learning system based on the structure and metadata of the traffic samples and may be utilized to perform tests on the API servers.

### BACKGROUND

As organizations embrace offering cloud and mobile services, many business challenges are encountered. For example, maintaining control over corporate applications and data can be difficult. Additionally, making data and applications available to third parties via application programming interfaces (APIs) increases security risks and makes contract enforcement difficult. Moreover, ensuring scalability and manageability as adoption grows as well as adapting data for consumption creates significant obstacles. Further, as organizations migrate to an open enterprise model, connecting disparate data and applications across a multitude of environments (e.g., legacy, cloud, mobile), particularly when changes are proposed, create many potential points of failure in a production setting.

Depending on the API service (i.e., microservice) being utilized or the user that is actually initiating an API call, the structure of the API call may vary. Further, as a system goes into production, the usage of the system may no longer be definable by the designer of the system. This results in an extremely tedious and time-consuming effort to manually determine the structure of the API call so that test data can be created. Unfortunately, existing solutions do not currently enable an efficient method for determining the actual per-identifier structure of an API call which inhibits the ability to properly test production models, inform caching systems or scaling systems, or enforce contracts, using the actual per-identifier message structure of API calls for the model when changes to the models are proposed.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to deep content inspection of API traffic. More particularly, embodiments of the present disclosure relate to utilizing models, based on the structure and metadata of API traffic samples, to perform tests on an API server. Initially, messages are received from users of an API at an API gateway. The messages comprise a structure and metadata and are intended for an API server. The API gateway selectively communicates copies of the messages to a traffic sampler. The traffic sampler comprises a database of traffic samples, a machine learning system, and a database comprising one or more models. The traffic sample communicates the models corresponding to usage of the API servers to the API gateway. The models are built by the machine learning system based on the structure and metadata of the traffic samples and may be utilized to perform tests on the API servers.

### BRIEF DESCRIPTION OF THE DRAWINGS

The present invention is described in detail below with reference to the attached drawing figures, wherein:

FIG. 1 is a block diagram showing a system that provides statistical deep content inspection of API traffic to create per-identifier interface contracts, in accordance with an embodiment of the present disclosure;

FIG. 2 is block diagram showing an exemplary traffic sampling pattern, in accordance with embodiments of the present disclosure;

FIG. 3 is a block diagram showing a machine learning system that utilizes API traffic samples to create test data, in accordance with embodiments of the present disclosure;

FIG. 4 is a flow diagram showing a method of receiving a model corresponding to a usage of an API server, in accordance with embodiments of the present disclosure;

FIG. 5 is a flow diagram showing a method of building a model based on a usage pattern of an API server, in accordance with embodiments of the present disclosure;

FIG. 6 is a flow diagram showing a method of testing an API server without requiring the use of actual test data, in accordance with embodiments of the present disclosure; and

FIG. 7 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

An application programming interface (API) is a set of procedures, protocols, and tools that are utilized to build software applications. APIs are often utilized to communicate between and/or integrate multiple components or services provided by applications. A variety of environments can benefit from APIs including web-based systems, operating systems, database systems, computer hardware, software libraries, and the like.

An API client refers to an interface that enables a user to utilize one or more services provided by an API server. The user may make requests or API calls to the API server from the API client for functionality provided by an application that utilizes the API server. An API gateway may broker API calls and responses between the API client and the API server.

An API server provides one or more services that provide functionality of a particular application. Operations may be requested on behalf of a particular application by a user via an API call at the API client.

An API call may refer to a login, save, query, or other operation in which a call is made by a user via a client application (i.e., the API client) to a server on behalf of a particular application that uses the API client. An API call may include operations requested via the web-based client application to multiple servers or services, in a particular order.

An API gateway provides a single entry point into a system of services provided by API servers. API calls for any API server or service provided by the API servers is received from the web-based client application via the API gateway. Similarly, any response from any API server or service provided by the API servers is received by the web-based client application via the API gateway. API calls or responses may be provided by the API gateway synchronously or asynchronously. The API gateway may aggregate responses provided from the API server to the API client.

As noted in the background, many business challenges are encountered when organizations embrace offering cloud and mobile services. In particular, when changes to production models are proposed, many potential points of failure are exposed. Even if manual efforts have been made by a designer of the system to understand the structure of API calls for a particular API server or service, depending on the API service being utilized or the user that is actually initiating the API call, the structure of the API call may vary. Further, as a system goes into production, the usage of the system may no longer be definable by the designer of the system. This results in an extremely tedious and time-consuming effort to manually determine the structure of the API call. Unfortunately, existing solutions do not currently enable an efficient method for determining the actual per-identifier structure of an API call which inhibits the ability to properly test production models, inform caching systems or scaling systems, or enforce contracts, using the actual per-identifier message structure of API calls for the model when changes to the models are proposed.

Embodiments of the present disclosure relate to deep content inspection of API traffic. More particularly, embodiments of the present disclosure relate to utilizing models, based on the structure and metadata of API traffic samples, to perform tests on an API server. Initially, messages are received from users of an API at an API gateway. The messages comprise a structure and metadata and are intended for an API server. The API gateway selectively communicates copies of the messages to a traffic sampler. The traffic sampler comprises a database of traffic samples, a machine learning system, and a database comprising one or more models. The traffic sample communicates the models corresponding to usage of the API servers to the API gateway. The models are built by the machine learning system based on the structure and metadata of the traffic samples and may be utilized to perform tests on the API servers.

Given that the API gateway imposes a common element in network traffic and allows deep content inspection, API traffic can be sampled so that it creates a minimized or selectable load and data volume, but statistically represents all of the API traffic passing through the system. Using gateway-based deep content inspection, unique factors can be mined. For example, identity, source, destination, message structure, target API server, and other operationally defined data items may be identified from the message flow. To do so, a pipelined machine learning approach can be utilized to classify similar API messages, group the similar API messages by identifiers, derive the message structures, and create a per-identifier group of message structures. Statistically, the overall traffic volume and relative volumes are apparent which enables a relatively small data set to accurately represent the actual traffic.

In embodiments, using the per-identifier contract (i.e., the payload content or parameters that are utilized in the message structure) created with minimal traffic volume, several valuable artifacts can be derived. For example, real world test regimes, using the message structures, can be created without the need for actual test data. Additionally, the parameters and the message structure enables per-customer, per-user, or per-identity regression analysis to be performed for API evolution. Attacker and abuser signatures may also be identified by understanding normal parameter and message structure patterns. Further, given the sampling, the machine learning system can identify payload content patterns, resulting in content inspection that corresponds to usage patterns. This enables the machine learning system to produce predictive behavior. For example, the machine learning system can determine that between certain hours of the evening, queries for restaurants increase by a certain percentage. This enables an organization to drive caching or the scaling of resources based on that data.

Accordingly, one embodiment of the present disclosure is directed to a method. The method comprises receiving a first command from a receiving a message from a user of an Application Programming Interface (API) client at an API gateway. The message comprises a structure and metadata and being intended for an API server. The method also comprises selectively communicating, by the API gateway, a copy of the message to a traffic sampler. The traffic sampler comprises a database of traffic samples, a machine learning system, and a database comprising one or more models. The method further comprises receiving, from the traffic sampler, a model corresponding to a usage of the API server built by the machine learning system. The model is based on the structure and metadata of the traffic samples.

In another embodiment, the present disclosure is directed to a computer storage medium storing computer-useable instructions that, when used by at least one computing device, cause the at least one computing device to perform operations. The operations comprise receiving traffic samples at a machine learning system. Each of the traffic samples is a message intended for an Application Programming Interface (API) server and comprises a structure and metadata. The operations also comprise building a model, at the machine learning system, based on the structure and metadata of the traffic samples. The model corresponds to a usage pattern of the API server. The operations further comprise communicating the model to an API gateway. The model can be utilized by the API gateway to detect requests for the API server that are not consistent with the usage pattern.

In yet another embodiment, the present disclosure is directed to a computerized system. The system includes a processor and a computer storage medium storing computer-useable instructions that, when used by the processor, cause the processor to receive a message from an Application Programming Interface (API) client at an API gateway. The message comprises a structure and metadata and being intended for an API server. A copy of the message is selectively communicated by the API gateway to a traffic sampler. The traffic sampler includes a database comprising traffic samples, a machine learning system, and a database comprising one or more models. A model corresponding to a usage of the API server is requested form the machine learning system. The model is based on the structure and metadata of the traffic samples and can be utilized to automate test messages. Utilizing the automated test messages, a stress test is performed on the API server without requiring use of actual test data.

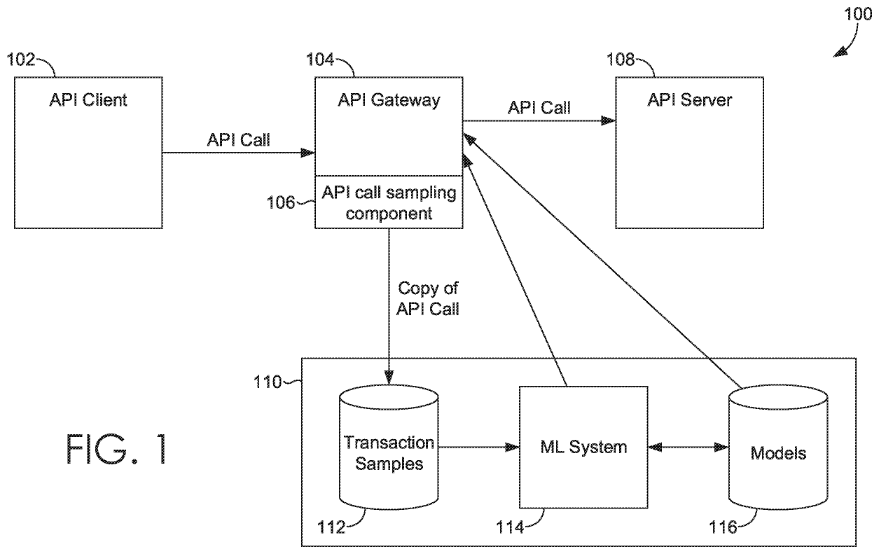

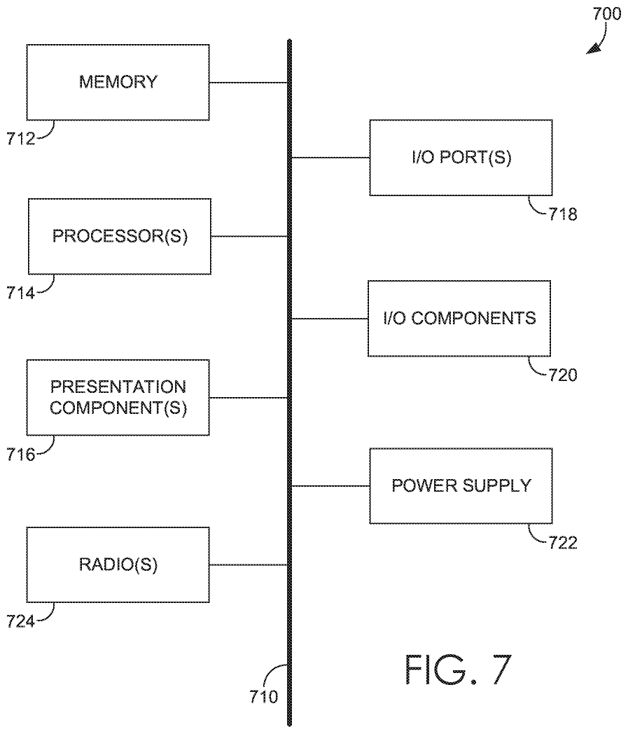

Referring now to FIG. 1, a block diagram is provided that illustrates a deep content deep content inspection system 100 that provides statistical deep content inspection of API traffic to create per-identifier interface contracts, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The deep content inspection system 100 may be implemented via any type of computing device, such as computing device 700 described below with reference to FIG. 7, for example. In various embodiments, the deep content inspection system 100 may be implemented via a single device or multiple devices cooperating in a distributed environment.

It should be understood that any number of inspection engines may be employed within the deep content inspection system 100 within the scope of the present disclosure. Each may comprise a single device or multiple devices cooperating in a distributed environment. For instance, the inspection engine 110 (or any of its components: transaction samples 112, machine learning system 114, models 116) may be provided via multiple devices arranged in a distributed environment that collectively provide the functionality described herein. In other embodiments, a single device may provide the functionality of multiple components of the deep content inspection system 100. For example, a single device may provide the inspection engine 110 and/or the API call sampling component 106. In some embodiments, some or all functionality provided by the inspection engine 110 (or any of its components) and/or the API call sampling component 106 may be provided by the API gateway 104. Additionally, other components not shown may also be included within the deep content inspection system 100.

As noted, the deep content inspection system 100 generally operates to provide deep content inspection of API traffic. As shown in FIG. 1, the deep content inspection system 100 may include API client 102, API gateway 104, API call sampling component 106, API server 108, and inspection engine 110. It should be understood that the deep content inspection system 100 shown in FIG. 1 is an example of one suitable computing system architecture. Each of the components shown in FIG. 1 may be implemented via any type of computing device, such as computing device 700 described with reference to FIG. 7, for example. Additionally, other components not shown may also be included within the environment.

As described above, an API call may refer to a login, save, query, or other operation in which a call is made by an API client 102 to an API server 108 on behalf of a particular application. An API call may include operations requested via the API client 102 to multiple servers or services (such as API server 108), and may be in a particular order.

API client 102 generally provides an interface that enables users to utilize one or more services provided by API server 108. To do so, API client 102 may initiate an API call to the API server 108 on behalf of a particular application that uses the API server 108. The API call may be a login request or a save, query, or other operation in response to a user utilizing the particular application. In some embodiments, the API client 102 may make an API call to multiple servers or services, in a particular order. The particular order may comprise part of the message structure. In another example, API calls might always come from a particular geographic region. If an API call originates from an area outside this particular geographic region, it is an anomaly that may be worth further examination. In yet another example, the message structure may constrain a particular field as part of the message structure. For example, a zip code in the United States is numeric and a set number of characters.

For example, assume there are two applications, application 1 and application 2, and three API servers, API server A, API server B, and API server C. Part of the message structure corresponding to application 1 might be that application 1 always calls API server A, API server B, and API server C, in that order. On the other hand, part of the message structure corresponding to application 2 might be that application 2 always calls API server C, API server B, and API server A, in that order. Each message structure is part of the use signature of the corresponding applications can help identify the legitimacy of the application that is making the call. As can be appreciated, by understanding patterns of use (i.e., the use signature), individual dialects of the API can be learned to drive other aspects of the system (e.g., testing, regression analysis, attack detection, use detection, caching systems or scaling systems, performance management, or contract enforcement), which will be discussed in more detail below.

API server 108 generally provides one or more services that provide functionality of a particular web-based application. Operations may be requested on behalf of a particular application by a user via an API call at the API client 102. As mentioned, API server 108 may provide multiple services on behalf of the web-based application. A response provided by the API server 108 is communicated to the API client 102, in some cases, by an API gateway (such as API gateway 104).

API gateway 104 generally provides a single entry point into a system of services provided by API servers (such as API server 108). API gateway 104 encapsulates the internal system architectures provided by API servers (such as API server 108) and provides an API that is tailored to API client 102. API gateway 104 is responsible for routing all API calls made by API client 102 to the appropriate service provided by API server 108. In some embodiments, API gateway invokes multiple services and aggregates the results. In this way, API gateway 104 provides an endpoint that enables API client 102 to retrieve all responses provided by the multiple services with a single request. Further, any API servers that utilize the API gateway 104 are transparent to the API client 102. In other words, the API client believes the API gateway 104 is the actual API server it is communicating with.

API call sampling component 106 generally samples API calls and communicates copies of the sample API calls (i.e., traffic samples or transaction samples) to inspection engine 110. API calls mays be sampled at a low capture rate (e.g., 1:10000) so that a performance impact on API gateway 104 is minimized. Relative traffic levels can be provided by API call sampling component 106 in the copies of sample API calls communicated to inspection engine 110 by training the API call sampling component 106 to recognize various message structures corresponding to the API calls. For example, usage pattern (e.g., Uniform Resource Identifiers (URIs)) can be utilized to generate a message sample plan by approximating the traffic patterns at the API gateway 104. In another example, API call sampling component 106 can filter the API calls based on unique user identification of the API calls (e.g., API key, Internet Protocol address, credential hash, other headers, and the like). Each of these techniques can facilitate the API call sampling component 106 to sample messages that statistically represent actual usage of the various API servers that utilize the API gateway 104. In some embodiments, the API call sampling component 106 anonymizes the data of the traffic samples prior to communicating the traffic samples to the inspection engine 110.

API server 108 generally provides one or more services that provide functionality of a particular web-based application. Operations may be requested on behalf of a particular application by a user via an API call at the API client 102, as described above.

Inspection engine 110 generally receives the sample API calls (i.e., traffic samples) from API call sampling component 106 and identifies patterns in the traffic samples. The patterns may be identified using various filters, parameters of interest, and/or subsets of data (such as by partitioning the data into different buckets with subsets of data filtered out). Inspection engine 110 comprises a transaction samples 112, a machine learning component 114, and models 116. Initially, inspection engine 110 may utilize data that is included in the traffic samples to derive field types associated with each traffic sample. The data and/or field types can be used by machine learning component 114 to build the model or profile corresponding to the structure and metadata of the traffic samples. In some embodiments, the model may be communicated by machine learning component 114 back to the API gateway 104 and/or API call sampling component 106. In embodiments, the model may be utilized by API call sampling component 106 to facilitate the API call sampling component 106 sampling messages that statistically represent usage.

As mentioned, machine learning component 114 builds the model or profile corresponding to the structure and metadata of the traffic sample. The model may be stored in a database of models 116. The models may be utilized by machine learning component 114 to generate test data (i.e., test API calls) that can be communicated to API gateway 104. Additionally, the machine learning component 114 may utilize the model created by various collections of traffic samples to generate unique user application level models. The machine learning component 114 may utilize the model created by various collections of traffic samples to generate user interface contract models per user. Alternatively, the machine learning component 114 may utilize the model created by various collections of traffic samples to generate general application level usage models.

In some embodiments, the models enable the API call sampling component 106 to sample API calls based on the API calls corresponding to a particular model. This may enable the API gateway 104 to more accurately test the API server 108 with test data using a test plan that is based on observed traffic at the API gateway 104.

In some embodiments, the machine learning component 114 utilizes the model to create test data by replacing all data characters and numbers with greeked data (e.g., all data characters replaced with predetermined data characters such as “z”, all numbers replaced with predetermined numbers such as “0”) so that actual test data is not required. Similarly, the data may be hashed. In this way, the structure of the model is sufficient to properly test the flow of data between the API client and the API server. As such, stress tests can easily be performed on the API server as well as performance based on changes to the underlying microservices infrastructure without the need for actual test data. The model may also be utilized to generate test traffic (e.g., for regressions testing, load testing, etc.).

Machine learning component 114 may utilize one or more machine learning algorithms. For example, a generic decision tree is a decision support tool that arrives at a decision after following steps or rules along a tree-like path. While most decision trees are only concerned about the final destination along the decision path, alternating decision trees take into account every decision made along the path and may assign a score for every decision encountered. Once the decision path ends, the algorithm sum all of the incurred scores to determine a final classification. In some embodiments, the alternating decision tree algorithm may be further customized. For example, the alternating decision tree algorithm may be modified by wrapping it in other algorithms.

A machine learning algorithm may use a generic cost matrix. The intuition behind the cost matrix is as follows. If the model predicts a member to be classified in group A, and the member really should be in group A, no penalty is assigned. However, if this same member is predicted to be in group B, C, or D, a 1-point penalty will be assigned to the model for this misclassification, regardless of which group the member was predicted to be in. Thus, all misclassifications are penalized equally. However, by adjusting the cost matrix, penalties for specific misclassifications can be assigned. For example, where someone who was truly in group D was classified in group A, the model could increase the penalty in that section of the cost matrix. A cost matrix such as this may be adjusted as needed to help fine tune the model for different iterations, and may be based on the specific patient in some embodiments.

With regards to a multi-class classifier, some machine learning algorithms, such as alternating decision trees, generally only allow for the classification into two categories (e.g. a binary classification). In cases where it is desired to classify three or more categories, a multi-class classifier is used.

In order to assist the alternating decision tree in selecting best features for predictive modeling, an ensemble method called rotation forest may be used. The rotation forest algorithm randomly splits the dataset into a specified number of subsets and uses a clustering method called Principal Component Analysis to group features deemed useful. Each tree is then gathered (i.e., “bundled into a forest”) and evaluated to determine the features to be used by the base classifier.

Various alternative classifiers may be used to provide the closed-loop intelligence. Indeed, there are thousands of machine learning algorithms, which could be used in place of, or in conjunction with, the alternating decision tree algorithm. For example, one set of alternative classifiers comprise ensemble methods.

Ensemble methods use multiple, and usually random, variations of learning algorithms to strengthen classification performance. Two of the most common ensemble methods are bagging and boosting. Bagging methods, short for “bootstrap aggregating” methods, develop multiple models from random subsets of features from the data (“bootstrapping”), assigns equal weight to each feature, and selects the best-performing attributes for the base classifier using the aggregated results. Boosting, on the other hand, learns from the data by incrementally building a model, thereby attempting to correct misclassifications from previous boosting iterations.

Regression models are frequently used to evaluate the relationship between different features in supervised learning, especially when trying to predict a value rather than a classification. However, regression methods are also used with other methods to develop regression trees. Some algorithms combine both classification and regression methods; algorithms that used both methods are often referred to as CART (Classification and Regression Trees) algorithms.

Bayesian statistical methods are used when the probability of some events happening are, in part, conditional to other circumstances occurring. When the exact probability of such events is not known, maximum likelihood methods are used to estimate the probability distributions. A textbook example of Bayesian learning is using weather conditions, and whether a sprinkler system has recently gone off, to determine whether a lawn will be wet. However, whether a homeowner will turn on their sprinkler system is influenced, in part, to the weather. Bayesian learning methods, then, build predictive models based on calculated prior probability distributions.

Another type of classifiers comprise artificial neural networks. While typical machine learning algorithms have a pre-determined starting node and organized decision paths, the structure of artificial neural networks are less structured. These algorithms of interconnected nodes are inspired by the neural paths of the brain. In particular, neural network methods are very effective in solving difficult machine learning tasks. Much of the computation occurs in “hidden” layers.

By way of example and not limitation, other classifiers and methods that may be utilized include (1) decision tree classifiers, such as: C4.5—a decision tree that first selects features by evaluating how relevant each attribute is, then using these attributes in the decision path development; Decision Stump—a decision tree that classifies two categories based on a single feature (think of a single swing of an axe); by itself, the decision stump is not very useful, but becomes more so paired with ensemble methods; LADTree—a multi-class alternating decision tree using a LogitBoost ensemble method; Logistic Model Tree (LMT)—a decision tree with logistic regression functions at the leaves; Naive Bayes Tree (NBTree)—a decision tree with naive Bayes classifiers at the leaves; Random Tree—a decision tree that considers a pre-determined number of randomly chosen attributes at each node of the decision tree; Random Forest—an ensemble of Random Trees; and Reduced-Error Pruning Tree (REPTree)—a fast decision tree learning that builds trees based on information gain, then prunes the tree using reduce-error pruning methods; (2) ensemble methods such as: AdaBoostM1—an adaptive boosting method; Bagging—develops models using bootstrapped random samples, then aggregates the results and votes for the most meaningful features to use in the base classifier; LogitBoost—a boosting method that uses additive logistic regression to develop the ensemble; MultiBoostAB—an advancement of the AdaBoost method; and Stacking—a method similar to boosting for evaluating several models at the same time; (3) regression methods, such as Logistic Regression—regression method for predicting classification; (4) Bayesian networks, such as BayesNet—Bayesian classification; and NaiveBayes—Bayesian classification with strong independence assumptions; and (4) artificial neural networks such as MultiLayerPerception—a forward-based artificial neural network.

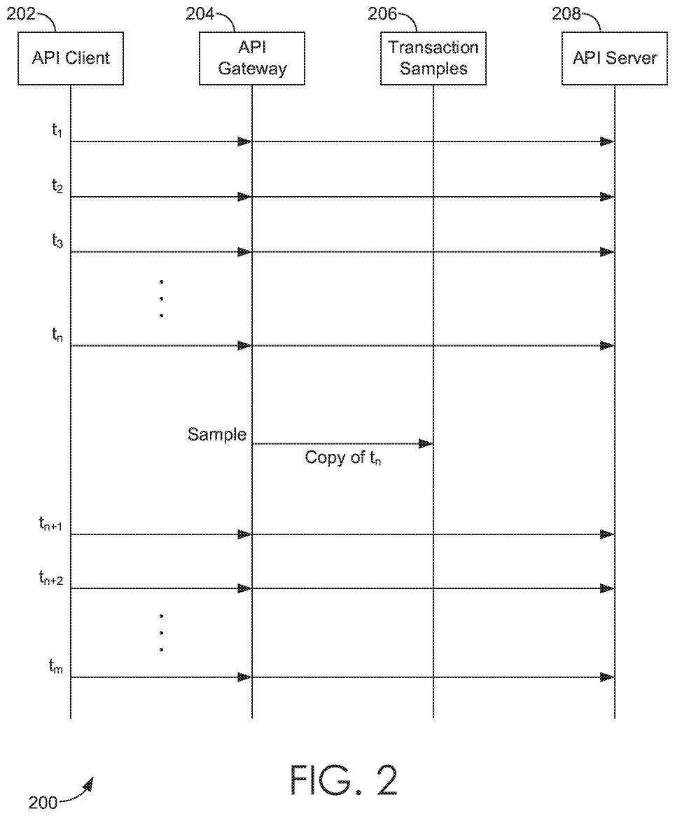

As shown in FIG. 2, a block diagram illustrates an exemplary traffic sampling pattern, in accordance with embodiments of the present disclosure. As illustrated, API calls t₁-tₘ are initiated at API client 202 and received at API gateway 204. Using any of the methods described herein, copies of API calls (e.g., copy of tₙ) are selectively communicated and stored by inspection engine (such as the inspection engine 110 of FIG. 1) as transaction samples 206. The copies of API calls being selectively communicated do not affect the normal data flow of the original API calls. In other words, all valid API calls received at API gateway 204 are communicated to the appropriate API server 208.

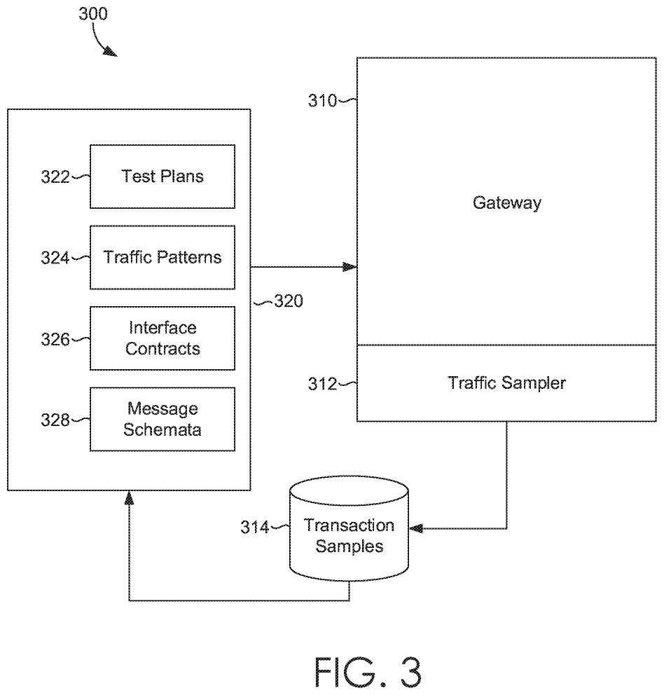

In FIG. 3, the deep content inspection system 300 shows a machine learning system that utilizes API traffic samples to create test data, in accordance with embodiments of the present disclosure. The deep content inspection system is illustrated with respect to communication between the machine learning system 320 and the API gateway 310, as described above. As shown, as API calls are received at gateway 310, traffic sampler selectively communicates copies of the API calls to transaction samples database 314. Machine learning system 320 utilizes the transaction samples 314 to build models corresponding to the API calls for test plans 322, traffic patterns 324, interface contracts 326, and message schemata 328. The models may be at a per-customer, per-user, or per-identity level.

Test plan models 322 may be created by machine learning system 320 to facilitate the gateway 310 in performing tests on an API client or API server. For example, utilizing the test plan models 322, test messages may be automated and utilized by the gateway 310 to perform tests on an API client or server (e.g., stress tests). In this way, the test plan models 322 can be utilized to simulate a particular API client or API server to determine performance based on real-world usage, without the need to use actual test data.

Traffic pattern models 324 may be created by machine learning system 320 to facilitate an understanding of how a user or application typically interacts with an API client. For example, a user or application may initiate an API call that communicates with multiple services provided by one or more API servers. The services may be called in a particular order or require responses in an asynchronous or synchronous manner. The traffic pattern models 324 enable the gateway 310 to detect fraud or attacks on an API client. In this way, the validity of users and API calls can be identified.

Interface contract models 322 may be created by machine learning system 320 to inform contract enforcement. The gateway 310 may utilize the interface contract models 322 to determine with a high degree of certainty whether a proposed change to the microservices architecture or implementation would affect performance after an upgrade has been implemented.

Message schemata models 322 may be created by machine learning system 320 to facilitate security and identify measures. For example, the gateway 310 may utilize the message schemata models 322 to identify signatures of use patterns for a particular user or API client. The signatures of use patterns can also be utilized by the gateway 310 to detect fraud or attacks on an API client. In this way, the validity of users and API calls can be identified.

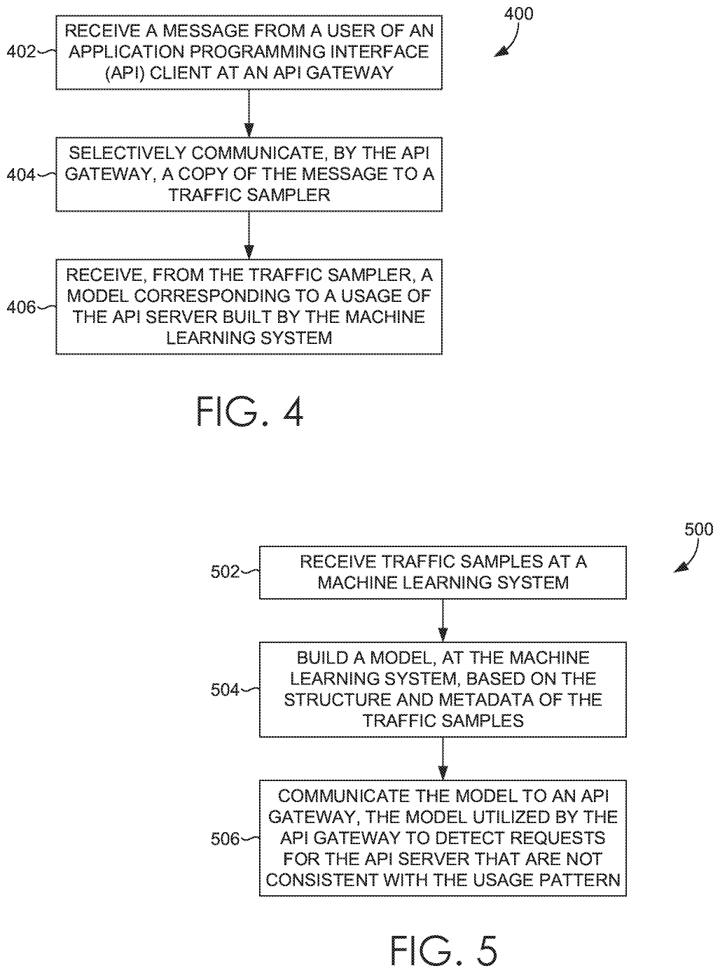

Turning now to FIG. 4, a flow diagram is provided that illustrates a method 400 of receiving a model corresponding to a usage of an API server, in accordance with embodiments of the present disclosure. For instance, the method 400 may be employed utilizing the deep content inspection system 100 of FIG. 1. As shown at step 402, a message is received from a user of an Application Programming Interface (API) client at an API gateway. The message comprises a structure and metadata and being intended for an API server.

At step 404, a copy of the message is selectively communicated by the API gateway to a traffic sampler. The traffic sampler comprises a database of traffic samples, a machine learning system, and a database comprising one or more models. The message may be selectively communicated based on a policy, a URI or message type, or a unique user identification corresponding to the user.

In some embodiments, a selection of a parameter of interest is received. The copy of the message may be selectively communicated to the traffic sampler in accordance with the parameter of interest. The parameter of interest may be based on a unique user identification. The unique user identification may be one or more of an API key, an IP address, or a credential hash.

In embodiments, a copy of the message is stored in the database comprising traffic samples. In some embodiments, the copy of the message is normalized before it is stored in the database of traffic samples. For example, data characters and numbers in the message may be replaced with predetermined data characters and numbers. In another example, a hash function may be applied to the message. Normalizing the message may include deriving field data types from the copy of the message. In some embodiments, a machine learning system (such as machine learning system 320 of FIG. 3) analyzes a number of normalized messages to derive the field data types. For example, the machine learning system may identify that each of the messages comprise five-digit integers, so the machine learning systems derives that the field data type is likely an integer. Furthermore, the machine learning system may identify that each of the five-digit integers occur in a certain range (e.g., 10000 to 99999); thus, the machine learning system may determine the field data type is likely a zip code.

At step 406, a model corresponding to a usage of the API server and built by the machine learning system is received from the traffic sampler. The model is based on the structure and metadata of the traffic samples. The model may be utilized to automate test messages. The test message may enable the API gateway to perform tests on the API server. In some embodiments, the test messages are based on a usage pattern of the user of the API server or a usage pattern of the API server.

In some embodiments, the model corresponds to a usage pattern of the API server by the user. The usage pattern of the API server by the user may be utilized by the API gateway to enhance authentication for the user. In other embodiments, the model corresponds to a usage pattern of the API server by a plurality of users. The usage pattern of the API server by the plurality of users may be utilized by the API gateway to detect attacks on the API server. The usage pattern may additionally be utilized by the API gateway to scale resources for the API server.

In FIG. 5, a flow diagram is provided that illustrates a method 500 of building a model based on a usage pattern of an API server, in accordance with embodiments of the present disclosure. For instance, the method 500 may be employed utilizing the deep content inspection system 100 of FIG. 1. As described above and as shown at step 502, traffic samples are received at a machine learning system. Each of the traffic samples is a message intended for an API server and comprises a structure and metadata.

At step 504, a model is built, by the machine learning system, based on the structure and metadata of the traffic samples. The model corresponds to a usage pattern of the API server.

At step 506, the model is communicated to an API gateway. The model can be utilized by the API gateway to detect requests for the API server that are not consistent with the usage pattern.

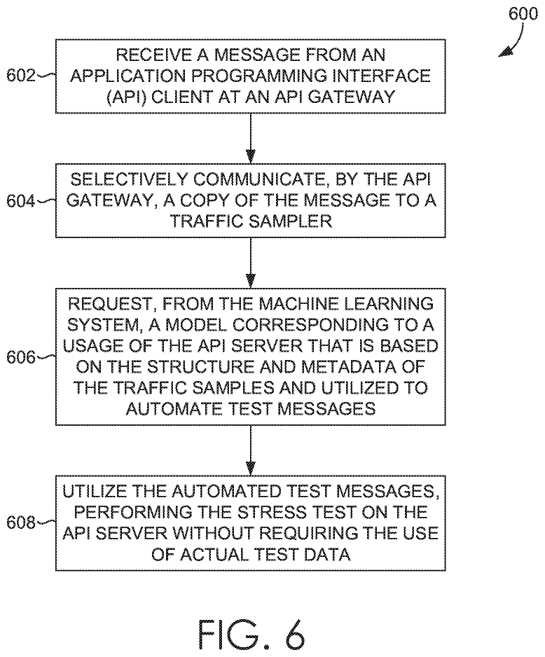

Referring to FIG. 6, a flow diagram is provided that illustrates a method 600 of testing an API server without requiring the use of actual test data, in accordance with embodiments of the present disclosure. For instance, the method 600 may be employed utilizing the deep content inspection system 100 of FIG. 1. As described above and as shown at step 602, a message is received from an API client at an API gateway. The message comprises a structure and metadata and is intended for an API server.

At step 604, the API gateway selectively communicates a copy of the message to a traffic sampler. The traffic sampler includes a database comprising traffic samples, a machine learning system, and a database comprising one or more models.

At step 606, a model corresponding to a usage of the API server that is based on the structure and metadata of the traffic samples is requested from the machine learning system. The model can be to automate test messages.

At step 608, the automated test messages are utilized to perform a stress test on the API server without requiring use of actual test data.

Having described embodiments of the present disclosure, an exemplary operating environment in which embodiments of the present disclosure may be implemented is described below in order to provide a general context for various aspects of the present disclosure. Referring to FIG. 7 in particular, an exemplary operating environment for implementing embodiments of the present disclosure is shown and designated generally as computing device 700. Computing device 700 is but one example of a suitable computing environment and is not intended to suggest any limitation as to the scope of use or functionality of the inventive embodiments. Neither should the computing device 700 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 7, computing device 700 includes a bus 710 that directly or indirectly couples the following devices: memory 712, one or more processors 714, one or more presentation components 716, input/output (I/O) ports 718, input/output (I/O) components 720, and an illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

As can be understood, embodiments of the present disclosure provide for an objective approach for providing deep content inspection of API traffic to create per-identifier interface contracts. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving a message from a user of an Application Programming Interface (API) client at an API gateway, the message comprising a structure and metadata and being intended for an API server;
selectively communicating, by the API gateway, a copy of the message to a traffic sampler, the traffic sampler comprising a database of traffic samples, a machine learning system, and a database comprising one or more models; and
receiving, from the traffic sampler, a model corresponding to a usage of the API server built by the machine learning system, the model based on the structure and metadata of the traffic samples.

2. The method of claim 1, further comprising, utilizing the model, automating test messages, the test messages enabling the API gateway to perform tests on the API server.

3. The method of claim 1, wherein the copy of the message is stored in the database comprising traffic samples.

4. The method of claim 2, wherein the test messages are based on a usage pattern of the API server.

5. The method of claim 1, wherein the message is selectively communicated based on a policy, a URI or message type, or a unique user identification corresponding to the user.

6. The method of claim 1, wherein the copy of the message is normalized before it is stored in the database of traffic samples.

7. The method of claim 6, wherein normalizing the copy of the message comprises deriving field data types of the message.

8. The method of claim 6, wherein normalizing the copy of the message comprises replacing data characters and numbers in the message with predetermined data characters and numbers.

9. The method of claim 6, wherein normalizing the copy of the message comprises applying a hash function to the message.

10. The method of claim 1, wherein the model corresponds to a usage pattern of the API server by the user.

11. The method of claim 10, further comprising, utilizing the usage pattern of the API server by the user, enhancing authentication for the user.

12. The method of claim 1, wherein the model corresponds to a usage pattern of the API server by a plurality of users.

13. The method of claim 12, further comprising, utilizing the usage pattern of the API server by the plurality of users, detecting attacks on the API server.

14. The method of claim 12, further comprising scaling resources for the API server based on the usage pattern.

15. The method of claim 1, further comprising receiving a selection of a parameter of interest.

16. The method of claim 15, wherein the copy of the message is selectively communicated to the traffic sampler in accordance with the parameter of interest.

17. The method of claim 15, wherein the parameter of interest is based on a unique user identification.

18. The method of claim 17, wherein the unique user identification is one or more of an API key, an IP address, or a credential hash.

19. A computer storage medium storing computer-useable instructions that, when used by at least one computing device, cause the at least one computing device to perform operations comprising:
receiving traffic samples at a machine learning system, each of the traffic samples being a message intended for an Application Programming Interface (API) server and comprising a structure and metadata;
building a model, at the machine learning system, based on the structure and metadata of the traffic samples, the model corresponding to a usage pattern of the API server; and
communicating the model to an API gateway, the model utilized by the API gateway to detect requests for the API server that are not consistent with the usage pattern.

20. A computerized system comprising:
a processor; and
a computer storage medium storing computer-useable instructions that, when used by the processor, cause the processor to:
receive a message from an Application Programming Interface (API) client at an API gateway, the message comprising a structure and metadata and being intended for an API server;
selectively communicate, by the API gateway, a copy of the message to a traffic sampler, the traffic sampler including a database comprising traffic samples, a machine learning system, and a database comprising one or more models;
request, from the machine learning system, a model corresponding to a usage of the API server that is based on the structure and metadata of the traffic samples and utilized to automate test messages; and
utilizing the automated test messages, perform a stress test on the API server without requiring use of actual test data.
